(19) United States
(12) Patent Application Publication
(10) Pub. No.: US 2020/0230756 A1
(43) Pub. Date: Jul. 23, 2020

(54) MACHINE TOOL

(71) Applicant: DECKEL MAHO PFRONTEN GMBH, Pfronten (DE)

(72) Inventors: Robert JUNG, Pfronten (DE); Alfred GEISSLER, Pfronten (DE); Stefan KIPKE, Durach (DE)

(73) Assignee: DECKEL MAHO PFRONTEN GMBH, Pfronten (DE)

(21) Appl. No.: 16/625,076

(22) PCT Filed: Jan. 30, 2019
(86) PCT No.: PCT/EP2019/052270

§ 371 Date: Dec. 20, 2019

(30) Foreign Application Priority Data
Jan. 30, 2018 (DE) 10 2018 201 419.1

(51) Int. Cl. B23Q 1/44; B23Q 1/01; B23Q 1/62

(52) U.S. Cl. CPC B23Q 1/445; B23Q 3/15722; B23Q 1/626; B23Q 1/015

(57) ABSTRACT

A machine tool with a machine bed, on the upper side of which a machine stand is arranged, a working spindle which can be displaced in a first, second, and third direction of movement with is mounted with the spindle sleeve. The spindle sleeve includes a sleeve housing which is guided along guide rails which are arranged on the machine stand and can be moved axially in the first direction and the working spindle supporting the tool can be moved in and out of the sleeve housing in the same direction of movement.

The present invention relates to a machine tool for machining workpieces with a working spindle with a spindle sleeve and the construction of a machine tool with a working spindle on a machine stand which can be displaced in three directions of movement, in particular traversing a chip channel.

From the prior art, various drilling, milling and/or turning machines whose working spindles have a spindle sleeve, are known. In principle, a spindle sleeve is a hollow drilled working spindle in stationary machine tools suitable for axial movement. A hollow shaft, the working spindle, is used in cutting machines with rotating tools, such as drilling machines, boring mills or milling machines to transmit the torque to the tool and the tool feed. It is drilled out at one end to accommodate various tools. For the working spindle configured as a spindle sleeve, a manual or automated axial movement of the spindle relative to the support or the spindle carrier is provided. This sleeve axis (usually referred to as the w axis) can be configured either as a positioning axis, i.e. the position is firmly set in advance for the following machine operation, or a feed axis, i.e. the position is changed during the machining operation as a feed movement. In contrast to the transverse slide, only the rotating parts of the spindle are axially displaced, while the support or spindle housing is fixed. For this purpose, the spindle sleeve is mounted several times, mostly in roller bearings, to absorb the radial and axial forces, however, it can be displaced in the axial direction relative to the housing to realize the adjustment movement. To transmit the rotation movement and the torque, the spindle sleeve is usually connected to the gear via gear wheels, pulleys, couplings etc. or other suitable elements. On turning machines, the tailstock spindle is often referred to as the spindle sleeve.

From DE 10 2009 058 649 A1, for example, a drilling and milling machine with a milling carriage is known, which is equipped with an additional turning tool carriage. For this purpose, a horizontal milling carriage moving horizontally is provided on a milling carriage carrier mounted on a stand. In addition, a turning tool carriage supporting a corresponding turning tool holder moves horizontally on the horizontal milling carriage. The two carriages are configured so that they can be moved separately.

DE 10 2006 007 737 A1 shows a drilling spindle for a vertical machining center with hollow working spindle. The tool spindle is mounted in a spindle carriage which is horizontally retractable and extendable relative to a vertical carriage. The spindle itself can also be moved horizontally relative to the spindle carriage. The spindle carriage itself is mounted in a vertical carriage and penetrates it. It can be moved horizontally through the vertical carriage.

As introductorily mentioned, the invention also deals with the fundamental structure of a working spindle that can be displaced in three directions in relation to a chip collection chamber as well as a related machine construction concept.

EP 176233 A2, for example, discloses a machine concept in which two machine stands are arranged on a bed and connected by a bridge. A rectangular frame which can be moved vertically and horizontally, is arranged on the two interconnected machine stands in a vertical direction. Within this first frame, a second frame with a working spindle is provided which can be moved in vertical direction to the two frames. Below the frame arrangements, a chip channel is arranged in the machine bed, the longitudinal axis of which extends parallel to the spindle axis.

A similar machine concept, in which a working spindle displaceable in three spatial directions is arranged above a chip channel, is described in EP 2 865 485 B1. In this concept, machine stands are mounted on both sides of a machine bed and connected to each other by a forked bridge. On this bridge a spindle stock is mounted on guides, which can be moved horizontally and additionally vertically in the direction of the spindle axis.

The object of the invention is to optimize the machine concepts described above with regard to the movement paths of the working spindle, rigidity of the spindle carrier, positionability of the tool to the workpiece/machine table and with regard to the chip feed.

This object or partial aspects thereof are solved by machine concepts as described in the independent claims 1 and 13.

The machine tool according to the invention is preferably configured as a horizontal machining center, i.e. the working spindle is arranged parallel to the surface of the machine table and moves in a horizontal direction.

A machine tool according to invention comprises a machine bed on the upper side of which a machine stand is arranged. The machine stand can be arranged on the machine bed or laterally on the machine bed. Preferably, the machine stand is configured with at least two machine stand bodies which can be moved relative to each other and which can be configured as block bodies. A first machine stand body can be movably mounted directly on the upper side of the machine bed, on which the workpiece table is also mounted. A second machine stand body can then be mounted on the first machine stand body and arranged on the machine bed so that it can move in a direction perpendicular to the traverse direction of the first machine stand body.

In embodiments of the machine configuration comprising a pivoting round table, a particularly practical design is achieved if the first machine stand body can be moved in a direction parallel to the pivot axis of the pivoting round table, for example via a horizontal carriage on the machine bed. This allows the size of the machine bed to be limited with regard to its surface area and at the same time the height of the machine as a whole. In addition, for most workpieces there are very effective, short traverse paths of the working spindle with a particularly load-stable structure.

The machine stand can carry a working spindle with spindle sleeve which can be displaced in a first, second, and third direction. In other words, in the machine tool according to the invention, the working spindle with spindle sleeve mounted on a machine stand can be displaced in the three spatial directions.

According to the invention, any spindle sleeve provided includes a sleeve housing which can be moved axially in the first direction with respect to the working spindle along guide rails mounted on the machine stand. The working spindle supporting the tool is additionally retractable and extendable into the sleeve housing in the first direction of movement.

In other words, the invention provides a working spindle with spindle sleeve which can be displaced in the same direction by two different drives, namely on the one hand by the working spindle which moves into and out of the sleeve housing, and on the other hand by the sleeve housing itself which can be moved along the guide rails on the machine stand.

A particular advantage of this “double” movability of the spindle sleeve in the first direction of movement is, in addition to the increased traverse path, that the traverse paths realized by the two mechanisms consisting of separate drives and guides run parallel to each other at least in sections, which in turn increases the rigidity and precision of the positionability of the working spindle.

Compared to the machine concept shown in DE 10 2006 007 737 A1 discussed above, for example, in which a horizontal spindle carriage penetrates a vertical spindle carriage, the rigidity of the machine construction can be considerably increased in this way. More precisely, increased rigidity is ensured over the entire traverse range in the direction of the first direction of movement resulting from the combined movement of a) movability of the sleeve housing with headstock and working spindle on the guides, and b) retraction and extension of the working spindle into the sleeve housing. This is of central importance precisely when machining large workpieces and the torques applied.

In a particularly preferred embodiment of the present invention, the machine stand includes two stationary machine stand bodies which are arranged laterally on the machine bed or on the machine bed and which are connected to each other by a bridge, wherein the sleeve housing on the bridge is movably arranged horizontally and parallel to the machine bed in the second direction of movement between the machine stand bodies. For this purpose, two horizontal guide rails are provided on the bridge, with which the sleeve housing can be moved in the horizontal direction with correspondingly high rigidity over a relatively wide area over the entire bridge.

A further advantage of this arrangement can be seen in the fact that the positioning of the working spindle with spindle sleeve between two machine stand bodies which ideally have the same configuration, results in an essentially thermosymmetrical structure of the machine concept, which is also of central importance for machining large workpieces.

Preferably, a pair of vertical guide rails are mounted on each side of the machine stand body. By means of vertical carriages guided in the guide rails, the bridge supporting the working spindle with spindle sleeve can be displaced vertically in the third direction. Here, too, high rigidity is ensured by the provision of a double guide.

Such embodiments of the invention are therefore characterized by the fact that all three directions of movement running at right angles to each other ensure guidance in double rails so that high rigidity over the entire traverse range can be guaranteed even with high traverse paths.

In a particularly practical embodiment of the present invention, four guide carriages are provided in each of the three designated (first, second, and third) directions of movement X, Y, and Z for moving the spindle.

A round table can be arranged on the machine bed, but also a pivoting table, the pivot axis of which is preferably arranged perpendicularly to the sleeve axis. This allows efficient five-axis machining of the workpiece.

Preferably a connecting element is arranged above the sleeve housing parallel to the bridge described above, wherein the connecting element connects the two machine stand bodies. The sleeve housing can be moved horizontally between the bridge and the connecting element on the bridge and parallel to the machine bed in the second direction of movement between the machine stand bodies. The connection of the two machine stand bodies by means of the connecting element results in a particularly stable construction of the machine tool, wherein vibrations arising during the movement of the sleeve housing can be reduced and/or avoided.

In a particularly practical embodiment, the bridge described above is arranged at a slant angle to the machine bed, whereby the sleeve is also oriented at a slant angle to the machine bed. Especially for large and/or heavy workpieces, the advantage is that the machining area of the spindle sleeve on the workpiece is enlarged by the inclined position of the spindle sleeve relative to the machine bed and large and heavy workpieces can be machined particularly efficiently, as these can only be pivoted to a limited extent by means of the pivoting table and the workpieces can be machined over a large surface area by the inclined position of the spindle sleeve with low pivotability.

In a preferred embodiment of the machine tool, the machine stand can be moved horizontally and in a second direction perpendicularly to the first direction. In this embodiment, the spindle sleeve arranged on the machine stand can be moved particularly precisely.

In a practical configuration, the machine stand comprises a first and second machine stand body and a connecting element arranged between the two machine stand bodies, wherein the two machine stand bodies and the connecting element are movable in a second direction perpendicular to the first direction.

The sleeve housing on the connecting element is preferably movable in the first direction and, by means of the connecting element between the two machine stand bodies, the sleeve housing is movable in a third direction perpendicular to the first and second direction. This configuration of the machine stand shows a particularly robust and rigid structure of the machine tool.

The machine stand is preferably arranged on the upper side of the machine bed.

It is particularly practical, if the machine stand is arranged on the side of the machine bed and can be moved horizontally and in the second direction. This results in a particularly compact structure with a small installation area of the machine tool.

In a simple configuration of the machine tool, the machine stand is configured in one piece. The sleeve housing can preferably be moved vertically in a third direction perpendicular to a first and second direction by means of a vertical carriage arranged on the side of the machine stand, whereby particularly short traverse paths of the spindle sleeve can be achieved. In addition, by means of this arrangement, a compact and particularly rigid structure of the machine tool is realized.

In a particularly preferred embodiment, a horizontal carriage is arranged between a machine stand movable on the upper side of the machine bed and the machine bed, wherein the horizontal carriage with the machine stand can be moved horizontally and in the second direction perpendicularly to the first direction. Since the machine stand is arranged on the horizontal carriage, the machine stand can be moved particularly precisely in the second direction, allowing the spindle sleeve to be moved precisely in this direction. At the same time, the machine tool is robust due to the construction of the machine stand on the horizontal carriage.

In a particularly preferred embodiment, a chip collection chamber runs in or below the machine bed, the axis of which can be arranged parallel to the sleeve axis. The pivoting table traverses the chip channel in its width direction so that a direct chip fall into the chip collection chamber is ensured by pivoting the pivoting table.

Due to the symmetrical structure of the machine, the machine stand is preferably set up with a three-point bearing.

A machine tool according to the invention is preferably set up for five-axis machining of a workpiece. A machine stand is arranged on a machine bed on which a working spindle is movably mounted in a first, second or third linear direction and two axes of rotation.

A pivoting table may also be arranged on the machine table, the pivot axis of which is perpendicular to the first direction of movement of the working spindle.

The arrangement of the pivot axis perpendicular to the longitudinal axis of the movable working spindle ensures an optimal positioning of the workpiece in relation to the tool clamped in the working spindle during five-axis machining. This can be explained by the fact that due to the pivoting movement of the pivoting table, at least within certain limits, the workpiece clamped on the pivoting table can be positioned further in said first direction of movement, in addition to the movability of the working spindle in said first (x-) direction, which may already include double movability due to the spindle sleeve structure described. This results in a total of three positioning mechanisms in said first direction of movement which enables considerably more efficient positioning of the workpiece and tool relative to each other.

The pivoting table is preferably arranged above a chip collection chamber provided in the machine bed so that falling chips can be discharged via this chip collection chamber by a conveyor screw.

In a preferred embodiment, the pivoting table traverses the chip collection chamber in its width. This results in an optimized removal of the resulting chip by waste from the machined workpiece directly into the chip collection chamber when the pivoting table is in a pivoting position.

In a preferred embodiment, the working spindle is displaced in the first direction of movement, perpendicular to the direction of the pivot axis, by a working spindle with a spindle sleeve. This can be the working spindle with spindle sleeve described above, which provides a so-called “double” movability by moving the sleeve housing with the headstock on the carriage and additionally the working spindle into the sleeve housing, or a simple spindle sleeve construction with “single” movability of the working spindle in said first axial direction.

Also in this machine concept, a practical embodiment can provide a two-part machine stand with a traversing bridge which results in the advantages according to the description above.

Preferably, a connecting element is arranged above the sleeve housing parallel to the bridge described above, wherein the connecting element connects the two machine stand bodies. The sleeve housing can be moved horizontally between the bridge and the connecting element on the bridge and parallel to the machine bed in the second direction of movement between the machine stand bodies. The connection of the two machine stand bodies by means of the connecting element results in a particularly stable structure of the machine tool, wherein vibrations arising during the movement of the sleeve housing are reduced and/or stopped.

In a particularly practical embodiment, the bridge described above is arranged at a slant angle to the machine bed, whereby the sleeve is also oriented at a slant angle to the machine bed. Especially for large and/or heavy workpieces, the advantage is that the machining area of the spindle sleeve on the workpiece is enlarged by the inclined position of the spindle sleeve relative to the machine bed and large and heavy workpieces can be machined particularly efficiently, as these can only be pivoted to a limited extent by means of the pivoting table and the workpieces can be machined over a large surface area by the inclined position of the spindle sleeve with low pivotability.

In a preferred embodiment of the machine tool, the machine stand can be moved horizontally and in a second direction perpendicularly to the first direction. In this embodiment, the spindle sleeve arranged on the machine stand can be moved particularly precisely.

In a practical configuration, the machine stand comprises a first and second machine stand body and a connecting element arranged between the two machine stand bodies, wherein the two machine stand bodies and the connecting element are movable in a second direction perpendicular to the first direction.

The sleeve housing on the connecting element is preferably movable in the first direction and, by means of the connecting element between the two machine stand bodies, the sleeve housing is movable in a third direction perpendicular to the first and second direction. This configuration of the machine stand shows a particularly robust and rigid structure of the machine tool.

The machine stand is preferably arranged on the upper side of the machine bed.

It is particularly practical, if the machine stand is arranged on the side of the machine bed and can be moved horizontally and in the second direction. This results in a particularly compact structure with a small installation area of the machine tool.

In a particular configuration of the machine tool, the machine stand is configured in one piece. The sleeve housing can preferably be moved vertically in a third direction perpendicular to a first and second direction by means of a vertical carriage arranged on the side of the machine stand, whereby particularly short traverse paths of the spindle sleeve can be achieved. In addition, by means of this arrangement, a compact and particularly rigid structure of the machine tool is realized.

In a particularly preferred embodiment, a horizontal carriage is arranged between a machine stand movable on the upper side of the machine bed and the machine bed, wherein the horizontal carriage with the machine stand can be moved horizontally and in the second direction perpendicularly to the first direction. Since the machine stand is arranged on the horizontal carriage, the machine stand can be moved particularly precisely in the second direction, allowing the spindle sleeve to be moved precisely in this direction. At the same time, the machine tool is robust due to the construction of the machine stand on the horizontal carriage.

In all machine concepts described here, a wheel magazine can be provided on the side of the machine stand or on one of the two machine stand bodies which enables tools to be changed into the working spindle via a manipulator. In an advantageous configuration, the wheel axis of the wheel magazine is provided vertically to the first direction of movement of the movement in the axial direction of the working spindle so that tools in the same direction can be easily removed from the wheel magazine and changed into the working spindle via a manipulator.

Further details and advantages of the present invention are explained by the following description of embodiments of the machine tool according to the invention on the basis of the drawings.

Therein:

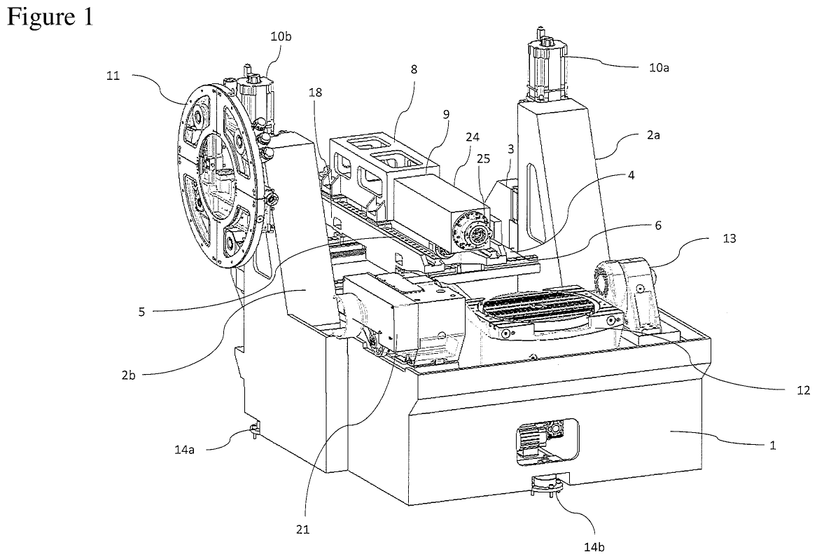

FIG. 1: shows a first embodiment of machine tool according to the invention in a perspective front view.

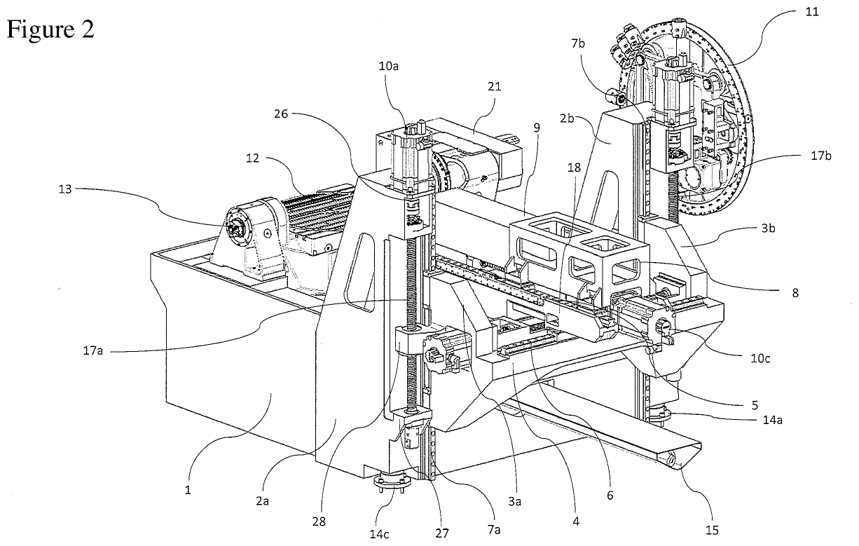

FIG. 2: shows an embodiment of a machine tool according to the invention in a perspective rear view.

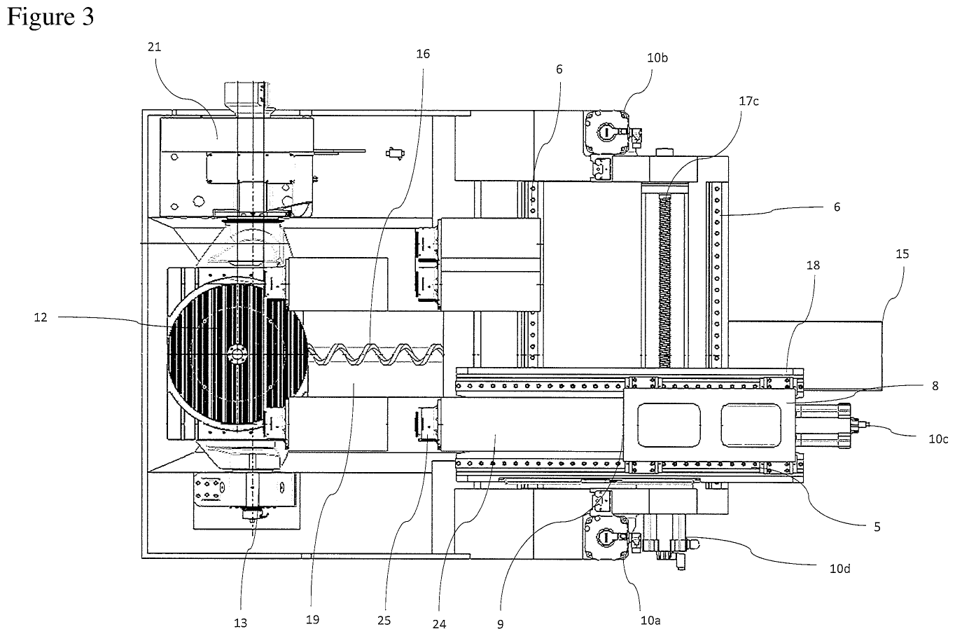

FIG. 3: shows an embodiment of a machine tool according to the invention in a top view.

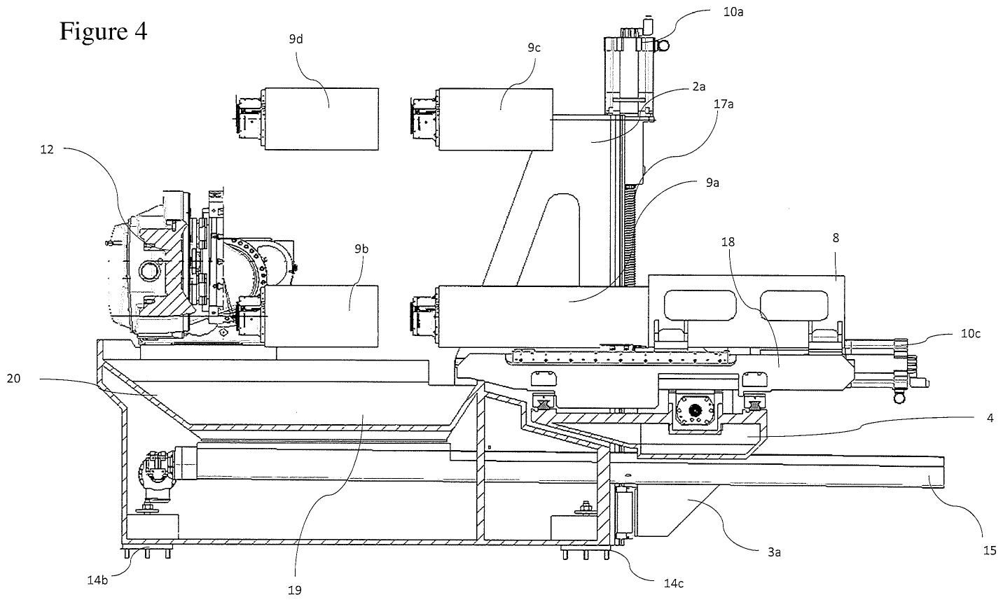

FIG. 4: shows an embodiment of a machine tool according to the invention in a perspective side view.

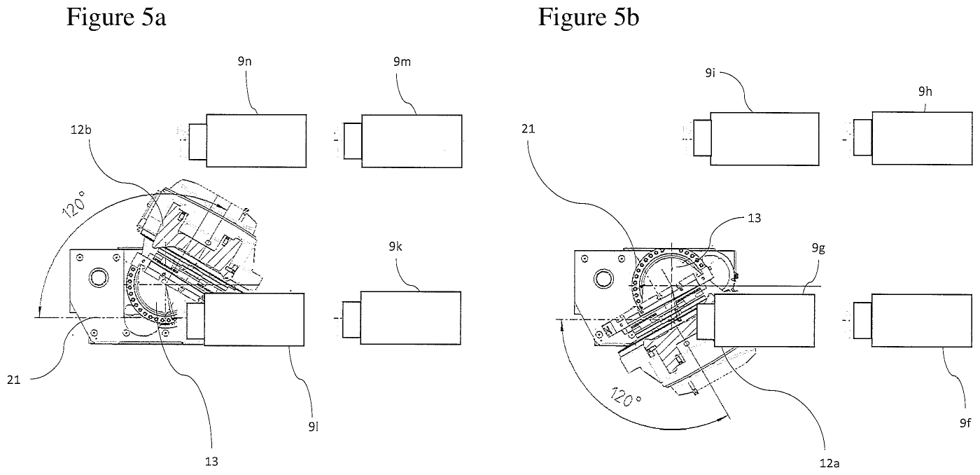

FIG. 5a: shows an embodiment of a pivoting round table in an overhead position of a machine tool according to the invention in a side view.

FIG. 5b: shows an embodiment of a pivoting round table in an upright position of a machine tool according to the invention in a side view.

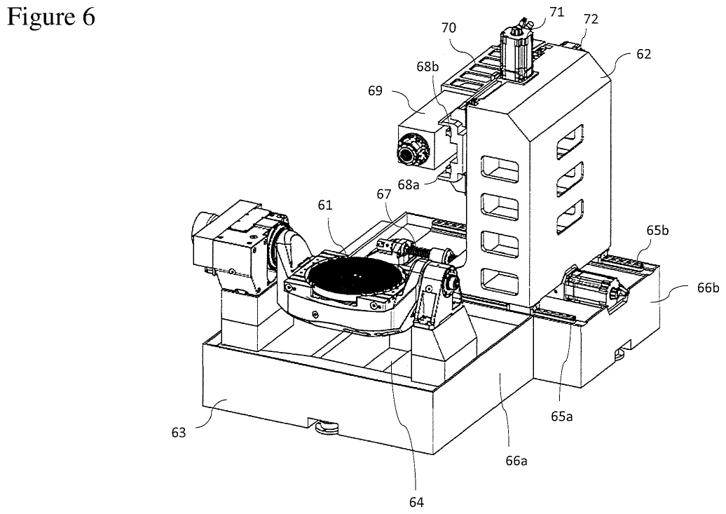

FIG. 6: shows a second embodiment of a machine tool according to the invention in a perspective front view.

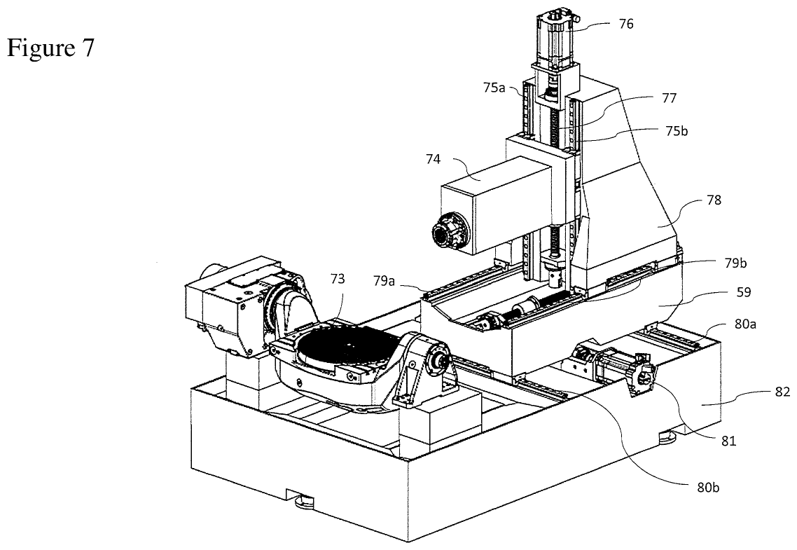

FIG. 7: shows a third embodiment of a machine tool according to the invention in a perspective front view.

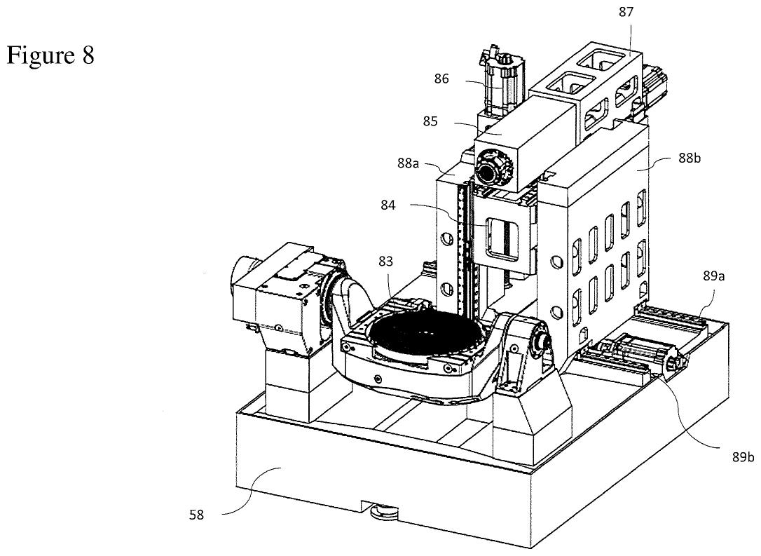

FIG. 8: shows a fourth embodiment of a machine tool according to the invention in a perspective front view

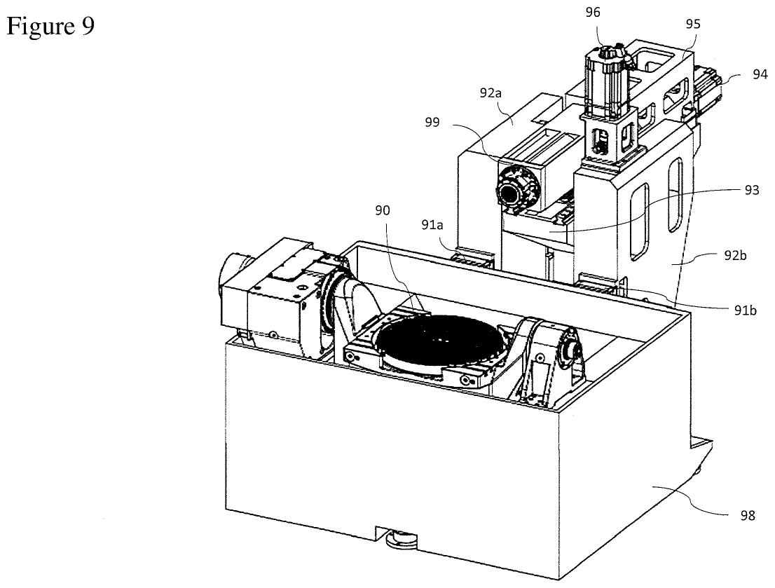

FIG. 9: shows a fifth embodiment of a machine tool according to the invention in a perspective front view

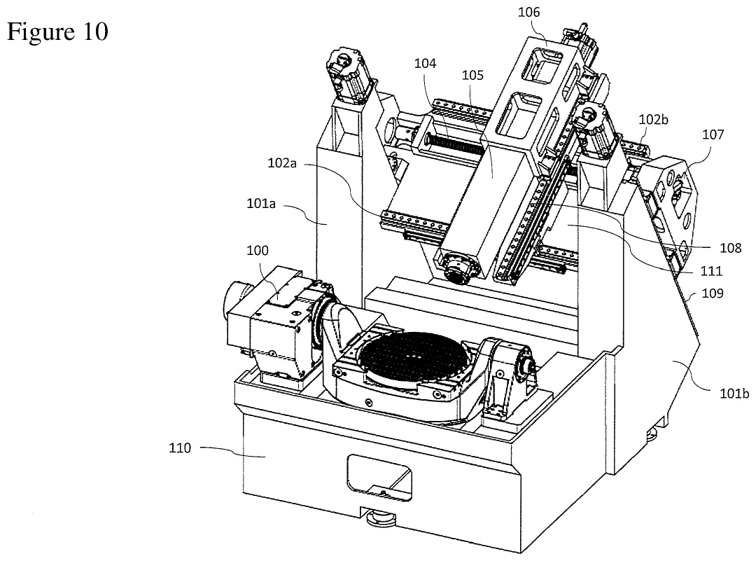

FIG. 10: shows a sixth embodiment of a machine tool according to the invention in a perspective front view.

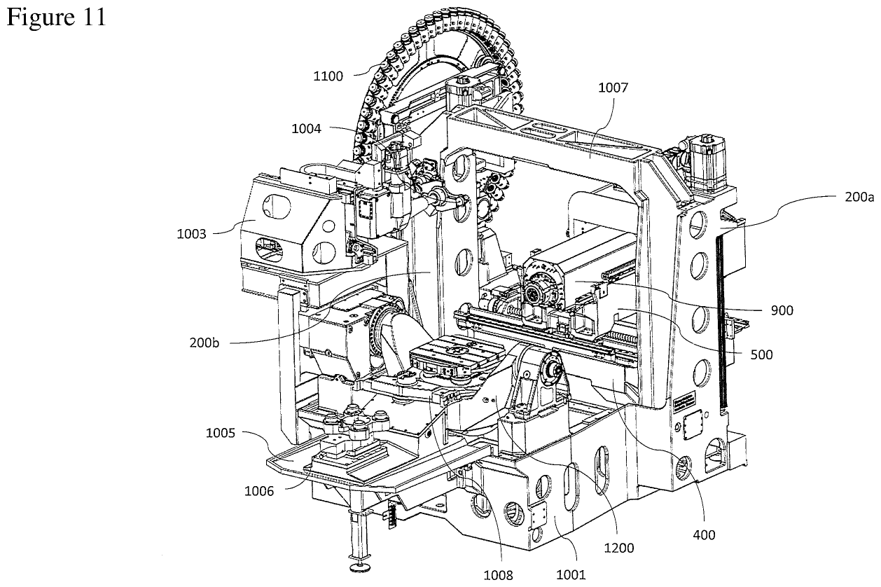

FIG. 11: shows a seventh example of a machine tool according to the invention.

FIG. 1 shows a first embodiment of a machine tool in a perspective front view. The machine tool comprises a machine bed 1 which stands firmly on the underside by three point bases 14a, 14b, 14c. With the three point bases 14a, 14b, 14c, the machine tool can be positioned particularly stable in the work space. The machine bed 1 has a square basic structure in which the sides are longer in the longitudinal direction than in the width.

On the machine bed 1, a machine stand 2 is configured trapezoidally as two parallel opposite machine stand bodies 2a, 2b. The construction of the two machine stand bodies 2a, 2b on the machine bed 2 results in a particularly high stiffness and at the same time a compact design of the machine tool.

FIG. 2 shows the machine tool in a perspective rear view. Vertical guide rails 7a, 7b are arranged on one of the side faces of each of the machine stand bodies 2a and 2b. In the guide rails 7a, 7b, a vertical carriage 3a, 3b is guided in each guide rail 7a, 7b, which has two carriages each, which are inserted in the guide rails 7a, 7b. The vertical carriages 3a, 3b are moved by ball screw drives 17a, 17b, whereby the ball screw drives 17a, 17b run vertically from top to bottom on one side surface of the machine stand bodies 2a, 2b and are supported by a lower support 27, a middle support 28 and an upper support 26. The lower support 27, the middle support 28, and the upper support 26 are located at the respective heights of the machine stand bodies 2a, 2b. A drive motor 10a, 10b of the respective ball screw drive 17a, 17b is mounted on the upper support 26. Using the ball screw drives 17a, 17b, the vertical carriages 3a, 3b can be precisely positioned in vertical direction. Therefore, the vertical carriages 3a, 3b are moved parallel to each other in vertical direction. Instead of ball screw drives 17a, 17b, other drives for the vertical carriages 3a, 3b are feasible, such as linear motors.

Between the two machine stand bodies 2a, 2b, a bridge 4 is arranged, which is moved in vertical direction by the vertical carriages 3a, 3b of the respective machine stand bodies 2a, 2b. The bridge 4 is a compact bridge construction, wherein on the bridge 4 between the two machine stand bodies 2a, 2b, two guide rails 6 are arranged parallel to each other in horizontal direction. A horizontal carriage 18 is mounted on the guide rails 6 which is guided between the two machine stand bodies 2a, 2b by a ball screw drive 17c provided in a free space in bridge 4 (see FIG. 3). The horizontal carriage 18 is arranged on four wagons, which are guided on the guide rails 6, whereby the horizontal carriage 18 is moved. A drive motor 10d is mounted on the outside of the bridge 4 which performs the power for the movement of the horizontal carriage 18 in the horizontal direction.

The construction of the machine stand bodies 2a, 2b, which are aligned parallel to each other, and the bridge 4, which can be moved vertically between them, results in a thermosymmetrical structure. The design of the bridge 4 provides great rigidity in a compact machine tool structure. Due to the compact structure of the machine tool, a steel cover for the machine tool, for example, can also be realized.

On the horizontal carriage 18, two guide rails 5 are mounted in a horizontal plane in the longitudinal direction of the machine bed 1. A sleeve housing 8 is guided in the longitudinal direction of the machine bed 1 on the guide rails 5. The sleeve housing 8 is box-shaped with a cavity, wherein a spindle sleeve 9 is at least partially enclosed by the sleeve housing 8 and at least partially fills the cavity. The spindle 9 consists of a headstock 24 and a working spindle 25, wherein the working spindle 25 can be displaced from and into the headstock 24. The sleeve housing 8 is moved by a ball screw drive 17d (not shown in FIGS. 1-5) mounted in the horizontal carriage 18 in the longitudinal direction of the machine bed 1 in a sleeve axis with four wagons arranged on the underside of the sleeve housing 8, which are placed on the guide rails 5, whereby the sleeve housing 8 can be moved on the guide rails 5. A drive motor 10c is connected to the construction of the horizontal carriage 18 and a rear side of the sleeve housing 8. By moving the sleeve housing 8 and extending and retracting the working spindle 25, the working spindle 25 moves twice in the direction of the sleeve axis, thereby extending the reach of the working spindle 25 in the sleeve axis. The sleeve housing 8 reinforces the rigidity of the sleeve 9, whereby the mobility of the spindle sleeve 9 in the direction of the sleeve axis is undisturbed and precise operation of the working spindle 25 is achieved. By positioning the spindle sleeve 9 in a sleeve housing 8 on the horizontal carriage 18 on the bridge 4, the machine tool is particularly stable during machining of workpieces, wherein at the same time the reach of the working spindle is extended due to the movability. Due to the guide rails 7a, 7b on the machine stand bodies 2a, 2b in the vertical direction, the guide rails 6 on the bridge 4 in the horizontal direction between the machine stand bodies 2a, 2b and the guide rails 5 on the horizontal carriage 18 in the longitudinal direction of the machine bed 1 in the direction of the sleeve axis, the working spindle 25 can be displaced in all three spatial directions. The guide rails 5, 6, 7 each appear twice, which results in a safer and more accurate guide. Other drives than ball screw drives 17c, 17d, such as linear motors, are feasible as drives for moving the horizontal carriage 18 and the sleeve housing 8.

A pivoting round table 12 is arranged on the machine bed 1. The pivoting round table is firmly mounted on the machine bed 1 by two pivoting arms 13. A pivoting round table motor 21 performs the movement of the pivoting round table 12. The pivoting round table 12 enables 5-axis machining by two rotation axes. The pivoting round table is moved by pivoting in the direction of the sleeve axis and in the vertical direction. The pivoting round table 12 can be rotated about its own axis by means of the second rotation axis, so that the greatest possible movement of a workpiece on the pivoting round table 12 is achieved. The pivoting movement of the pivoting round table 12 executes a circular path which can be described by a movement in two coordinate axes. Therefore, the pivoting of the pivoting round table 12 achieves further freedom of movement in the longitudinal direction of the machine bed 1 and in the vertical direction.

In an interior 19 on the inner sides of the machine bed 1, chip deflection devices 20 for deflecting the chips produced during workpiece machining are arranged. The chips falling from the chip deflection device 20 are guided into the chip channel 15. A chip worm 16 (see FIG. 3) arranged in the chip channel 15 guides the chips out of the chip channel 15 of the machine tool. A further illustration of the chip worm is shown in FIG. 3 and is described in more detail in the description of FIG. 3.

On an outer side surface on one of the machine stand bodies 2a, 2b, a wheel magazine 11 is mounted perpendicularly to the axis of the working spindle 25. The wheel magazine 11 guides tools which can be inserted into the working spindle 25 by means of a manipulator. The tools inserted in the working spindle 25 can in turn be removed from the working spindle 25 by the manipulator and inserted into the wheel magazine 11. The wheel magazine 11 allows a quick change of the tools from and into the working spindle 25, which increases the efficiency of the machine tool.

FIG. 3 illustrates the machine tool in a top view, showing the position of the spindle sleeve 9 in relation to the pivoting round table 12. Due to the movability of the spindle 9 in all three spatial directions through the different guide rails 5, 6, 7a, 7b, the spindle sleeve 9 can be moved in the entire area of the machine bed 1. As the working spindle 25 can be extended in the sleeve axis, the reach is extended up to the pivoting round table 12. The extended reach of the working spindle 25 and the pivoting of the pivoting round table 12 enable particularly precise machining of a workpiece. Due to the extended reach of the working spindle 25 in the direction of the sleeve axis, particularly wide and long workpieces can be machined without changing or correcting their position.

In the middle of the machine bed 1, FIG. 3 shows the chip worm 16 which is mounted in the longitudinal direction in the chip channel 15 in the interior 19 of the machine bed 1. The chips produced during machining of workpieces are transported out of the machine bed 1 by the chip worm 16 in the chip channel 15 so that chips which are a significant disturbance factor during machining are efficiently and quickly removed from the machining area.

FIG. 4 shows a side view of the machine tool in which the positioning of the spindle 9 to the pivoting round table 12 and the interior 19 of the machine bed 1 are shown. In the view, the pivoting round table is rotated by 90° so that the working spindle 25 of the spindle sleeve 9 is perpendicular to the pivoting round table 12. The extended reach of the working spindle 25 which results from the double movability of the spindle sleeve 9 makes it clear that the working spindle 25 can be displaced up to the pivoting round table 12. The structure of the machine tool is kept compact and achieves particularly high rigidity.

FIG. 5 illustrates the movement of the pivoting round table 12 during pivoting. The pivoting round table 12 can hold the table in upright position 12a as well as turn it in overhead position 12b. The pivoting arms move the pivoting round table 12 around a rotation axis on a circular path. The pivoting round table is rotated about its own axis by a further rotation axis. As shown in FIG. 5a, the spindle sleeve 9k, 9l, 9m, 9n can be moved in different heights and widths, wherein the pivoting round table 12 is positioned in overhead position 12b. FIG. 5b shows the position of the spindle sleeve 9f, 9g, 9h, 9i compared to the position of the pivoting round table 12 in normal position 12a of the pivoting round table 12. Due to the reach of the spindle sleeve 9 and the movability of the pivoting round table 12, a multitude of machining modes is feasible in which workpieces can be machined flexibly. Due to the overhead position 12b of the pivoting round table 12, it is possible for chips to fall directly into the chip channel 15.

FIG. 6 shows a second embodiment of a machine tool which, compared to the first embodiment, includes a one-piece machine stand 62 which can be moved on the upper side of the machine bed 63 in a horizontal direction perpendicular to the sleeve axis and in which the sleeve housing 70 can be moved laterally on the machine stand 62 in the vertical direction by means of a vertical carriage.

The machine tool includes the machine bed 63, the machine stand 62 and a spindle sleeve 69 which can be moved axially in a first direction. The machine bed 63 is divided into two areas, wherein a pivoting round table 61 is mounted in a first area 66a above the machine bed 63. A first and a second pivoting arm of the pivoting round table 61 are each mounted on a first and a second side wall of the machine bed in such a way that the pivoting round table is arranged centrally in the first area 66a of the machine bed 63. In the machine bed 63 below the pivoting round table 61, there is a chip collection chamber 64 for collecting the chips arising during the machining of a workpiece.

A second area 66b of the machine bed 63 is connected to the first area 66a of the machine bed 63 on a third side wall of the first area 66a. On an upper side of the second area 66b of the machine bed 63, two parallel guide rails 65a, 65b run perpendicularly to the first direction in a second direction. On the two guide rails 65a, 65b, the individual machine stand 62 is arranged, which can be moved by means of a motor and a ball screw drive 67. The machine stand 62 moves in the second direction perpendicularly to the spindle sleeve 69 which moves axially in the first direction. The ball screw drive 67 is arranged within the second area 66b of the machine bed 63 in the direction of the movability of the machine stand 62.

Two vertical guide rails running parallel to each other are arranged on the machine stand 62 so that a vertical carriage is movably arranged in vertical direction on one side surface of the machine stand 62. Two further guide rails 68a, 68b are arranged on the vertical carriage, by means of which a sleeve housing 70 guided laterally on the machine stand is movably arranged in the first direction. The sleeve housing 70 includes the spindle sleeve 69 which can be moved axially in the first direction into and out of the sleeve housing 70.

FIG. 7 shows a third embodiment of a machine tool. The machine tool includes a one-piece machine stand 78, which, in contrast to the second embodiment, is arranged on a horizontal carriage 59 so that the machine stand 78 can be moved on the horizontal carriage 59 on the upper side of the machine bed 82 in a direction perpendicular to the sleeve axis and the machine stand 78 can additionally be moved on the horizontal carriage 59 in the direction of the sleeve axis.

The machine tool includes the machine bed 82, the machine stand 78, and a spindle sleeve 74 which can be moved axially in a first direction. On the upper side of the machine bed 82, a pivoting round table 73 is arranged in a first area, as shown in FIG. 6. In a second area of the machine bed 82, two guide rails 80a, 80b are arranged parallel to each other in a second direction perpendicular to the first direction in the horizontal direction.

A horizontal carriage 59 is mounted on the guide rails 80a, 80b. The horizontal carriage 59 is moved in the second direction on the guide rails 80a, 80b by means of a motor and a ball screw drive. On the upper side of the horizontal carriage 59, two guide rails 79a, 79b, arranged parallel to each other, are mounted with orientation in the first direction. On the two guide rails 79a, 79b, the machine stand 78 can be moved in the first direction. A ball screw drive is mounted inside the horizontal carriage 59 by means of which the machine stand 78 is moved motor-driven.

Two guide rails 75a, 75b, arranged parallel to each other, are mounted vertically on one side surface of the machine stand 78. On the two vertically arranged guide rails 75a, 75b a sleeve housing 74 with integrated vertical carriage can be moved in vertical direction. Inside the machine stand 78, a ball screw drive 77 is installed, by means of which the headstock with integrated vertical carriage is moved by a motor 76 arranged on the upper side of the machine stand 78.

FIG. 8 shows a fourth embodiment of a machine tool which, compared to the first embodiment, includes a movable machine stand 88a, 88b comprising two machine stand bodies 88a, 88b and a connecting element 84 arranged between the two machine stand bodies 88a, 88b, wherein the two machine stand bodies 88a, 88b and the connecting element 84 are jointly movable horizontally and perpendicularly to the sleeve axis on the upper side of the machine bed 58.

The machine tool includes the machine bed 58, a pivoting round table 83 and guide rails 89a, 89b arranged on the upper side of the machine bed 58. The machine stand 88a, 88b can be moved in the second direction on the two guide rails 89a, 89b arranged on the machine bed. The machine stand 88a, 88b is made of a cast part, wherein the cast part is formed such that the machine stand 88a, 88b includes a first machine stand body 88a and a second machine stand body 88b, the wide sides of which are oriented parallel to each other and connected by the connecting element 84. On the inner side of the first machine stand body 88a and on the inner side of the second machine stand body 88b two parallel guide rails are mounted in vertical direction. The connecting element 84 between the first and second machine stand bodies 88a, 88b can be moved vertically between the inner surfaces of the first and second machine stand bodies 88a, 88b by means of the guide rails.

On the upper side of the connecting element 84, two guide rails arranged parallel to each other are arranged with orientation in the first direction. A sleeve housing 87 is movably mounted on the guide rails in the first direction. Inside the sleeve housing 87, a spindle sleeve 85 is arranged, which, in addition to the movability of the sleeve housing 87, is configured to move axially in the first direction from and into the sleeve housing 87.

FIG. 9 shows a fifth embodiment of a machine tool, wherein compared to the machine stand 88a, 88b of the fourth embodiment which is movable on the upper side of the machine bed, in the fifth embodiment, the machine stand 92a, 92b is arranged on an outer side of the machine bed 98 so that this is movable horizontally on the outer side of the machine bed 98 and in a direction perpendicular to the sleeve axis.

The machine tool comprises the machine bed 98, the machine stand 92a 92b, and a spindle sleeve 99 which can be moved axially in a first direction. The machine bed 98 includes a pivoting round table 90 of the same configuration as shown in FIGS. 6 to 8. Two parallel guide rails are mounted on the outside of the machine bed 98 which are oriented perpendicularly to the first direction in a second direction. The machine stand 92a, 92b is movable in the second direction on the outside of the machine bed 98 by means of a first and second guide shoe 91a, 91b on the guide rails, wherein the two guide shoes 91a, 91b are mounted on a first machine stand body 92a and on a second machine stand body 92b. The machine stand 92a, 92b is configured such that it is manufactured from one casting and includes the first machine stand body 92a and the second machine stand body 92b. The first and second machine stand bodies 92a, 92b are connected by a connecting element 93 between the first and second machine stand bodies 92a, 92b. On the inner surfaces of the first and second machine stand bodies 92a, 92b, guide rails are mounted in the vertical direction, by means of which the connecting element 93 between the first and second machine stand bodies 92a, 92b can be moved in the vertical direction.

Two guide rails are mounted on an upper side of the connecting element 93, which are oriented parallel to each other in the first direction. A sleeve housing 95 can be moved in the first direction on the two guide rails. The sleeve housing 95 includes the spindle sleeve 99 which can additionally be axially retracted and extended in the first direction in the sleeve housing.

FIG. 10 shows a sixth embodiment of a machine tool, in which a bridge-like structure of the machine stand comparable to the first embodiment is realized, wherein the bridge 111, in contrast to the first embodiment, is arranged between two stationary machine stand bodies 101a, 101b at an angle to the machine bed 110, so that the spindle sleeve 105 is also oriented at a slant angle to the machine bed 110.

The machine tool includes the machine bed 110, the machine stand 101a, 101b, and the spindle sleeve 108 which can be moved axially in a first direction. A pivoting round table 100 is arranged on the upper side of the machine bed 110. Two machine stand bodies 101a, 101b are arranged on the outside of the machine bed 110. The two machine stand bodies 101a, 101b are arranged so that on the rear side of the machine stand bodies 101a, 101b, a first and a second carriage 107 can be moved at a slant angle to the vertical on guide rails 109. The angle between the rear side of the machine stand bodies 101a, 101b and the vertical is approximately 45°. However, the angle between the rear side of the machine stand bodies 101a, 101b and the vertical is not limited to a certain angle and is preferably between 10° and 80°.

A bridge 111 mounted on the first and second carriage 109 is arranged between the two machine stand bodies 101a, 101b, which can be moved obliquely in a second direction by means of the two carriages 109 on the rear side of the two machine stand bodies 101a, 101b.

On the upper side of the bridge 111, two guide rails 102a, 102b oriented in a third direction are arranged parallel to each other, on which a carriage 108 can be moved in the third direction. By means of a ball screw drive 104 arranged on the bridge 111 and a motor, the movement of the carriage 108 in the third direction is carried out.

On the upper side of the carriage 108, two parallel guide rails are mounted which are oriented in the first direction. A sleeve housing 106 can be moved in the first direction on the two guide rails. The sleeve housing 106 includes the spindle sleeve 105 which can also be retracted and extended axially in the first direction.

In summary, the spindle sleeve 105 can be moved twice in the first direction by means of the retractability and extendibility from the sleeve housing 106 and by means of the movability of the sleeve housing 106. In addition, the sleeve 105 can be moved in the second and third directions by means of the carriages 3a, 3b and 59, wherein the first, second, and third directions are perpendicular to each other. Since the sleeve housing 106 with the sleeve 105 is movably arranged on the bridge 111 and the bridge 111 stands at a slant angle to the vertical, the sleeve 105 is also arranged at a slant angle to the pivoting round table 100 and the machine bed 110.

FIG. 11 shows a seventh embodiment of a machine tool in which a bridge-like structure of the machine stand is realized, as in FIGS. 1 to 4, wherein above the sleeve housing, a connecting element arranged parallel to the bridge connects the two machine stand bodies. The sleeve housing is furthermore movable on the bridge by means of the horizontal carriage between the bridge and the connecting element in the second direction perpendicular to the sleeve axis.

The invention is not limited to the embodiments shown in FIGS. 1-11, but includes further combinations of the details outlined in the description to create further embodiments that can be created on the basis of expert knowledge.

1. Machine tool with a machine bed (1, 63, 82, 58, 98, 110), on the upper side of which or laterally on the machine bed (1, 63, 82, 58, 98, 110) a machine stand (2, 62, 78) is arranged, on which a working spindle (25) with a spindle sleeve (9, 69, 74, 85, 99) which can be displaced in a first, second, and/or third direction of movement is mounted,
characterized in that
the spindle sleeve (9, 69, 74, 85, 99) includes a sleeve housing (8, 70, 87, 95, 106) which can be moved axially in the first direction along guide rails (5, 68a, 68b) mounted on the machine stand (2, 62, 78) and the working spindle (25) supporting the tool can be retracted and extended into the sleeve housing (8, 70, 87, 95, 106) in the same direction of movement.

2. Machine tool according to claim 1, characterized in that the machine stand (2) includes two stationary machine stand bodies (2a, 2b; 101a, 101b) which are connected via a bridge (4, 111), wherein the sleeve housing (8) is movably arranged on the bridge (4, 111) horizontally to the machine bed (1) in the second direction of movement between the machine stand bodies (2a, 2b, 101a, 101b) perpendicularly to the first direction of movement.

3. Machine tool according to claim 2, characterized in that guide rails (7a, 7b) are mounted on the side surfaces of the two machine stand bodies (2a, 2b), wherein vertical carriages (3a, 3b) are guided in the guide rails (7a, 7b) of one respective machine stand body (2a, 2b), through which the bridge (4) supporting the working spindle (25) with spindle sleeve (9) can be displaced perpendicularly to the first and second direction of movement in the third direction.

4. Machine tool according to claim 2 or 3, characterized in that a connecting element is arranged above the sleeve housing (8) and parallel to the bridge (4), which connects the two machine stand bodies (2a, 2b, 101a, 101b).

5. Machine tool according to claim 1, characterized in that the machine stand (62, 78) is arranged horizontally and movably in the second direction perpendicular to the first direction.

6. Machine tool according to claim 5, characterized in that the machine stand includes a first and a second machine stand body (88a, 88b, 92a, 92b) and a connecting element (84, 93) arranged between the two machine stand bodies (88a, 88b, 92a, 92b), such that the sleeve housing (87, 95) is movably arranged on the connecting element (84, 93) in the first direction and the sleeve housing (87, 95) is vertically movable by means of the connecting element (84, 93) in the third direction perpendicular to the first and second directions.

7. Machine tool according to claim 6, characterized in that the machine stand is arranged on the upper side of the machine bed (58).

8. Machine tool according to claim 6, characterized in that the machine stand is arranged laterally on the machine bed (98).

9. Machine tool according to claim 5, characterized in that the sleeve housing (70) can be moved vertically in the third direction perpendicular to the first and second directions by means of a vertical carriage arranged laterally on the machine stand (62, 78).

10. Machine tool according to claim 9, characterized by a horizontal carriage (59) arranged between the machine bed (82) and the machine stand (78) such that the horizontal carriage (59) is arranged with the machine stand (78) horizontally and movably in the second direction perpendicular to the first direction.

11. Machine tool according to claim 2, characterized in that the bridge (111) is arranged at a predetermined slant angle to the machine bed (110) such that the spindle sleeve (105) is also oriented at a slant angle to the machine bed (110).

12. Machine tool according to claim 1-11, characterized in that the machine tool includes a pivoting table (12) arranged on the machine bed (1) for 5-axis machining of a workpiece by the working spindle (25) with spindle sleeve (9), the pivot axis of which is arranged perpendicularly to the sleeve axis.

13. Machine tool for 5-axis machining of a workpiece comprising:
a machine bed (1),
a machine stand (2) which is arranged on the upper side or laterally on the machine bed (1);
a working spindle (25) which is mounted on the machine stand (2) in a horizontal arrangement and which is movably arranged in a first, a second, and/or a third direction of movement, characterized by
a pivoting table (12) which is arranged on the upper side of the machine bed (1) and the pivot axis of which extends perpendicularly to the longitudinal axis of the working spindle (25).

14. Machine tool according to claim 13, characterized in that the machine stand includes a first machine stand body which is movably arranged on or laterally on the machine bed in a direction parallel to the pivot axis of the pivoting table.

15. Machine tool according to claim 13 or 14, characterized in that the working spindle (25) is configured as an axially movable spindle sleeve (9).

16. Machine tool according to claim 14 or 15, characterized in that the machine stand (2) comprises two machine stand bodies (2a, 2b, 101a, 101b) which are connected via a bridge (4, 111), wherein the sleeve housing (8, 106) is arranged on the bridge (4, 111) so as to be movable horizontally and in the second direction of movement between the machine stand bodies (2a, 2b, 101a, 101b) perpendicularly to the first direction.

17. Machine tool according to claim 16, characterized in that guide rails (7a, 7b) are mounted on the two machine stand bodies (2a, 2b), wherein in the guide rails (7a, 7b) on both sides a vertical carriage (3a, 3b) is guided on the machine stand bodies (2a, 2b), and the bridge (4) can be moved by the vertical carriages (3a, 3b) in the third direction of movement perpendicularly to the first and second directions.

18. Machine tool according to one of the claims 16 to 17 of the patent, characterized in that a connecting element is arranged above the sleeve housing (8) and parallel to the bridge (4) connecting the two machine stand bodies (2a, 2b, 101a, 101b).

19. Machine tool according to one of claim 2, 3, 4, 16, 17 or 18, characterized in that the two machine stand bodies (2a, 2b) and the bridge (4) arranged between the machine stand bodies (2a, 2b) are arranged relative to one another such that a thermosymmetrical structure results.

20. Machine tool according to claim 14, characterized in that the machine stand (62, 78) is movably arranged perpendicularly and parallel to the pivot axis of the pivoting table (61, 73, 83, 90).

21. Machine tool according to claim 20, characterized in that the machine stand includes a first and a second machine stand body (88a, 88b; 92a, 92b) and a a connecting element arranged between the two machine stand bodies (88a, 88b) such that the sleeve housing (87, 95) is movably arranged on the connecting element (84, 93) in the first direction and the sleeve housing (87, 95) is vertically movable by means of the connecting element (84, 93) in the third direction perpendicular to the first and second directions.

22. Machine tool according to claim 21, characterized in that the machine stand is arranged on the upper side of the machine bed (58).

23. Machine tool according to claim 21, characterized in that the machine stand is arranged laterally on the machine bed (98).

24. Machine tool according to claim 14, characterized in that the sleeve housing (70) is vertically movable in the third direction perpendicular to the first and second directions by means of a vertical carriage arranged laterally on the machine stand (62, 78).

25. Machine tool according to claim 24, characterized by a horizontal carriage (59) arranged between the machine bed (82) and the machine stand (78) such that the horizontal carriage (59) is movably arranged with the machine stand (78) horizontally and in the second direction perpendicularly to the pivot axis of the pivoting table (73).

26. Machine tool according to claim 16, characterized in that the bridge (111) is arranged at a slant angle to the machine bed (110) such that the spindle sleeve (105) is also oriented at a slant angle to the machine bed (110).

27. Machine tool according to one of claims 14 to 26, characterized in that a chip collection chamber is formed in the machine bed (1), and the pivoting table (12) is arranged above the chip collection chamber.

28. Machine tool according to claim 1-27, characterized in that the machine tool includes a wheel magazine (11) the axis of which runs perpendicularly to the working spindle (25) and a manipulator for changing tools on the working spindle (25) and the wheel magazine (11), respectively.

29. Machine tool according to one of claims 1-28, characterized in that the machine bed (1) comprises a three-point base (14a, 14b, 14c) on the underside.
